(19) United States
(12) Patent Application Publication
(10) Pub. No.: US 2012/0065834 A1
(43) Pub. Date: Mar. 15, 2012

(54) DRIVING MANAGEMENT SYSTEM AND METHOD

(75) Inventors: Aline SENART, Le Bar sur Loup (FR); Marion MESNAGE, Antibes (FR); Scott W. KURTH, Arlington Heights, IL (US)

(73) Assignee: ACCENTURE GLOBAL SERVICES LIMITED, Dublin (IE)

(21) Appl. No.: 12/879,707

(22) Filed: Sep. 10, 2010

(51) Int. Cl. G06F 7/00

(52) U.S. Cl. 701/31.4; 701/29.1

(57) ABSTRACT

A driving management system includes a driving data collection module and a processing module. The driving data collection module, which is deployed within a vehicle, collects individual vehicle operation information for the vehicle in response to operation of the vehicle. The processing module compares the individual vehicle operation information with collective empirical vehicle operation information to provide individual comparison results. The processing module also provides vehicle operation feedback information to at least one user associated with the vehicle based on the individual comparison results. The collective empirical vehicle operation information is at least based on vehicle operation information for a plurality of other vehicles.

### FIELD

The present disclosure generally relates to driving management systems, and more particularly, to adjusting travel performance of vehicles associated with driving management systems.

### BACKGROUND

Modern vehicles are typically equipped with a variety of onboard sensors and computers for measuring and recording vehicle performance, diagnostic, and location data. These devices provide a great deal of information about the performance of the vehicle during operation. With rising fuel costs, one use of such information in driving management systems is to provide drivers and/or fleet vehicle managers with information about fuel economy related to the operation of the vehicle(s). Many vehicles display a measure of fuel economy such as the gas mileage in miles per gallon or the remaining drivable distance based on the current amount of fuel and fuel economy. While this information is helpful, it does not give the driver and/or fleet manager feedback on how specific driving actions impact (or may impact) fuel economy and/or consumption.

To address this shortcoming, systems have been proposed in which fuel efficiency can be improved by using a predefined model for a particular vehicle. In such systems, the vehicle can include an onboard system that uses the predefined model to suggest driving instructions to a driver when the driver's actions vary from the model. Although this method may be useful, it is based on an ideal model that can be inaccurate in real world situations. In addition, it is very difficult to create a model that accurately reflects conditions that the driver may experience.

Moreover, such systems tend to be focused solely on fuel efficiency/consumption and therefore do not attempt to optimize vehicle performance according to the various other dimensions that may influence what is considered to be beneficial use of a particular vehicle. That is, prior systems fail to adjust a broader concept of travel performance (which includes fuel efficiency and/or consumption) according to the specific usage context of a particular vehicle.

Accordingly, there is a need to provide a driving management system and method that can provide appropriate feedback information to a driver and/or fleet vehicle manager to improve travel performance of vehicle(s) and thus reduce overall operating costs associated with the vehicle(s).

### SUMMARY

The instant disclosure describes a driving management system that includes a driving data collection module and a processing module. The driving data collection module, which is deployed within a vehicle, collects individual vehicle operation information for the vehicle in response to operation of the vehicle. The processing module, which is operatively connected to the driving data collection module and may be deployed within the vehicle or remotely relative to the vehicle, compares the individual vehicle operation information with collective empirical vehicle operation information to provide individual comparison results. The processing module also provides vehicle operation feedback information to at least one user associated with the vehicle based on the individual comparison results. The collective empirical vehicle operation information is at least based on vehicle operation information for a plurality of other vehicles. When determining the vehicle operation feedback information, the processing module attempts to adjust a travel performance metric. A related method is also disclosed.

Among other features, the system and method provide users associated with one or more vehicles, such as vehicle fleet managers and/or drivers, vehicle operation feedback information that can be used by the user to improve travel performance of the one or more vehicles. For example, in one embodiment of travel performance, improving fuel efficiency can substantially reduce costs associated with operating one or more vehicles, in particular when used in conjunction with large fleets of vehicles. In addition, increasing fuel efficiency can substantially reduce air pollutants emitted by internal combustion engines associated with the vehicles. Other features will be recognized by those of ordinary skill in the art.

In an embodiment, the individual comparison results and, consequently, the vehicle operation feedback information are based on variables (i.e., controllable factors) and constraints (i.e., non-controllable factors) within the individual vehicle operation information and the collective empirical vehicle operation information. Specifically, one or more constraints within the individual vehicle operation information are identified and used to further identify a portion of the collective empirical vehicle operation information having substantially similar constraints. Thereafter, one or more empirical variables in the portion of the collective vehicle operation information are determined and used as the basis for comparison against corresponding vehicle variables of the individual vehicle operation information. In one embodiment, the one or more empirical variables used in this manner may be represented according to specific values obtained from the portion of the collective empirical vehicle operation information, e.g., a best, worst, average or median value for each such empirical variable. The vehicle operation feedback information can thus include suggested vehicle operation instructions that are based on vehicle variables that may be modified by the relevant user. For example, the suggested vehicle operation instructions can include driving information such as time of departure, speed, acceleration, driving route, braking, and/or transmission gear selection.

In yet another example, the driving management system includes a user interface operatively connected to the processing module. The user interface presents the vehicle operation feedback information. In one example, the user interface is deployed within the vehicle. In another example, the user interface is deployed remotely relative to the vehicle. In one example, a vehicle includes the driving management system.

In this manner, the present disclosure sets forth various improvements not found in the prior art.

### BRIEF DESCRIPTION OF THE DRAWINGS

The features of the present disclosure are set forth with particularity in the appended claims. These features and attended advantages will become apparent from consideration of the following detailed description, taken in conjunction with the accompanying drawings. One or more embodiments are now described, by way of example only, with reference to the accompanied drawings wherein like reference numerals represent like elements and in which:

FIG. 1 is a block diagram illustrating a driving management system according to the present disclosure;

FIG. 2 is a block diagram depicting various modules of the driving management system in greater detail;

FIG. 3 is a flowchart depicting operations that can be performed by the driving management system;

FIG. 4 is a flowchart depicting operations that can be performed by a processing module associated with one or more of the management modules; and

FIG. 5 illustrates an example of individual vehicle operation information collected to provide collective empirical vehicle operation information and use thereof.

### DETAILED DESCRIPTION

The following description is merely exemplary in nature and is in no way intended to limit the disclosure, its application, or uses. Unless noted otherwise, as used herein, the term “module” can include an electronic circuit, one or more processors (e.g., shared, dedicated, or group of processors such as but not limited to microprocessors, digital signal processors, co-processors or central processing units) and memory that execute one or more software or firmware programs, combinational logic circuits, application specific integrated circuits, and/or other suitable components that provide the described functionality. Furthermore, implementations of modules may be on the basis of shared components of the type noted above or, alternatively, individual modules may be implemented by dedicated components of the type noted above as a matter of design choice.

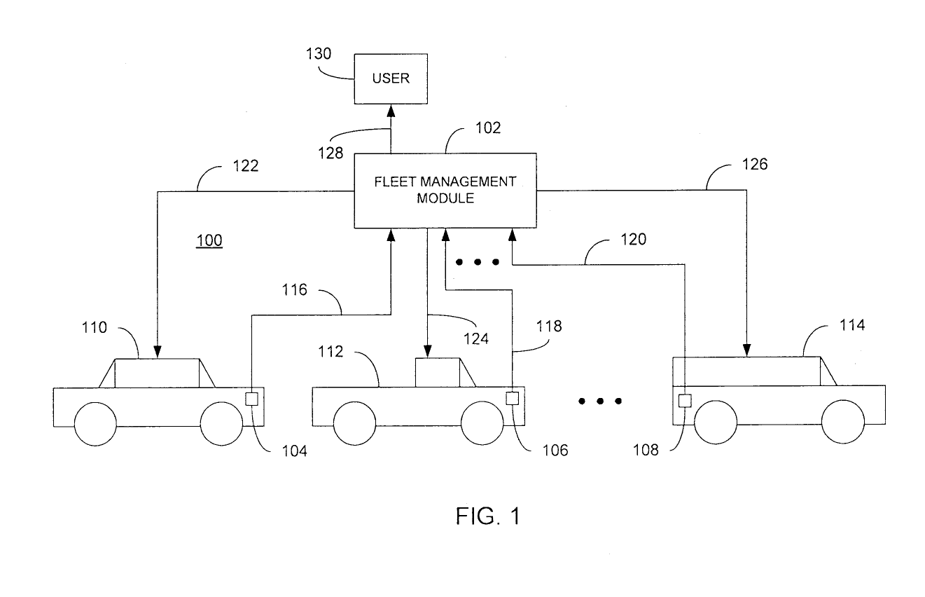

Referring now to FIG. 1, a block diagram of a driving management system 100 is depicted. In this example, the driving management system 100 includes a fleet management module 102 and multiple vehicle management modules 104, 106, 108 each of which is deployed within a respective vehicle 110, 112, 114. Generally, each vehicle 110, 112, 114 may comprise any type of conveyance having a human operator including, in one embodiment, motorized ground transportation devices such as automobiles, trucks, buses, motorcycles, etc. Furthermore, the vehicles 110, 112, 114 may be all of the same type/make/model or may be a mix of vehicles having different types/makes/models. In one embodiment, the number of vehicles operating within the purview of the driving management system 100 is sufficiently high that, for any given vehicle type/make/model, there are a number of other vehicles of the same type/make/model such that meaningful collective empirical vehicle operation information may be gathered, as described in further detail below. Each vehicle management module 104, 106, 108 collects respective individual vehicle operation information 116, 118, 120 in response to the operation (e.g., driving) of each respective vehicle 110, 112, 114. The individual vehicle operation information 116, 118, 120 can include fuel consumption information; vehicles parameters such as vehicle type, speed, acceleration, maintenance level, environmental parameters such as driver identity, road traveled, weather; vehicle position information (e.g., GPS information) for each respective vehicle 110, 112, 114; and/or other suitable information depending on the type of vehicle. For example, in connection with electric or hybrid electric vehicles, such information may include peak acceleration, peak deceleration, battery charge, average engine RPM, etc.

The fleet management module 102 is operatively connected to each of the vehicle management modules 104, 106, 108. For example, in one embodiment, the fleet management module 102 is operatively connected to each of the vehicle management modules 104, 106, 108 via a suitable known wireless connection such as through a cellular wireless network, a wireless local area network (WLAN), a Bluetooth wireless connection, and/or other suitable wireless connection. In another embodiment, the fleet management module 102 is operatively connected to each of the vehicle management modules 104, 106, 108 through a temporary physical connection such as a hardwire connection suitable to obtain engine diagnostics (e.g., On-Board Diagnostics (OBD or OBD II)) or other suitable physical connection. Where the connection (whether wired or wireless) between the vehicle management modules 104, 106, 108 and the fleet management module 102 is only intermittently available, each vehicle management module 104, 106, 108 may temporarily store its respective individual vehicle operation information 116, 118, 120 until such time that the connection is available for uploading of the individual vehicle operation information 116, 118, 120 to the fleet management module 102.

In one embodiment, as described in more detail below, the fleet management module 102 compares individual vehicle operation information 116, 118, 120 of one or more of the vehicles 110, 112, 114 with collective empirical vehicle operation information previously collected from one or more of the vehicles 110, 112, 114 to provide individual comparison results. For example, the fleet management module 102 can compare individual vehicle operation information 116 of a first vehicle 110 with collective empirical vehicle operation information previously collected from other vehicles 112, 114 (or a subset of the other vehicles 112, 114, as described below) to provide individual comparison results. As further described below, the individual comparison results may serve as the basis for optimizing a travel performance metric such as, for example, best fuel efficiency for the vehicle, shortest delivery time for a delivery route serviced by the vehicle, etc. or combinations thereof.

The fleet management module 102 uses the individual comparison results to provide vehicle operation feedback 122, 124, 126, 128 to a user associated with the vehicle 110, 112, 114 such as fleet manager 130 or an individual driver. As used herein, a fleet manager 130 may comprise one or more persons charged with overall management of a fleet of vehicles including, but not limited to, functions such as vehicle financing, vehicle maintenance, vehicle tracking and diagnostics, driver management, fuel management and health & safety management, etc. Although fleets of vehicles are often associated with certain types of businesses such as delivery companies, shipping companies, car rental companies, etc., the instant disclosure is not limited in this regard. That is, a “fleet” may be considered any grouping of vehicles sharing one or more similar characteristics, regardless whether they are associated with a single entity (e.g., a single business) or a large number of entities (e.g., individual owners). For example, a more traditional fleet of vehicles may comprise all of the delivery trucks for a given company, or all delivery trucks of a certain type/make/model across a number of companies utilizing such trucks. Similarly, a fleet may comprise all rental cars for one or more companies, or may comprise all passenger cars of a given type/make/model within a given region. Various other characteristics useful for establishing such groupings (e.g., vehicle age, manufacturing locations, date of most recent maintenance, etc.) and/or combinations thereof will be readily evident to those having ordinary skill in the art.

The vehicle operation feedback provides information suitable to suggest areas of improvement that the user can implement in order to improve travel performance of one or more of the vehicles 110, 112, 114. Examples of vehicle operation feedback can include speed, acceleration, vehicle maintenance (e.g., tire pressure, oil change, tune up, etc.), driving route, driver identification, vehicle type, fuel costs, air conditioning use, load, day and/or time factors, and/or other suitable vehicle operation feedback. The specific nature of the vehicle operation feedback 122, 124, 126, 128 depends on the type of user (i.e., driver or fleet manager) and the existence of various constraints and variables within the individual vehicle operation information and the collective empirical vehicle operation information, as further described below.

Rather than a centralized embodiment in which the fleet management module 102 performs the comparisons between vehicle operation information and the subsequent determination of vehicle operation feedback information, an alternative decentralized implementation may be employed. Specifically, each of the multiple vehicle management modules 104, 106, 108 may compare the individual vehicle operation information 116, 118, 120 of one or more of the vehicles 110, 112, 114 with the collective empirical data previously collected from one or more of the vehicles 110, 112, 114 to provide individual comparison results. For example, the collective empirical vehicle operation information may be occasionally provided to each vehicle management module 104, 106, 108 (e.g., through an on-demand or periodically pushed model) such that they are able to perform the comparisons between the collective empirical vehicle operation information and respective individual vehicle operation information 116, 118, 120 to provide respective individual comparison results. As in the centralized embodiment, each of the multiple vehicle management modules 104, 106, 108 uses the individual comparison results to provide vehicle operation feedback to a user associated with the vehicle 110 such as a driver for example. In this embodiment, the fleet management module 102 serves to manage and distribute the collective empirical vehicle operation information. Those having ordinary skill in the art will appreciate that hybrid implementations, comprising both centralized and de-centralized operations of the type described herein, may be possible.

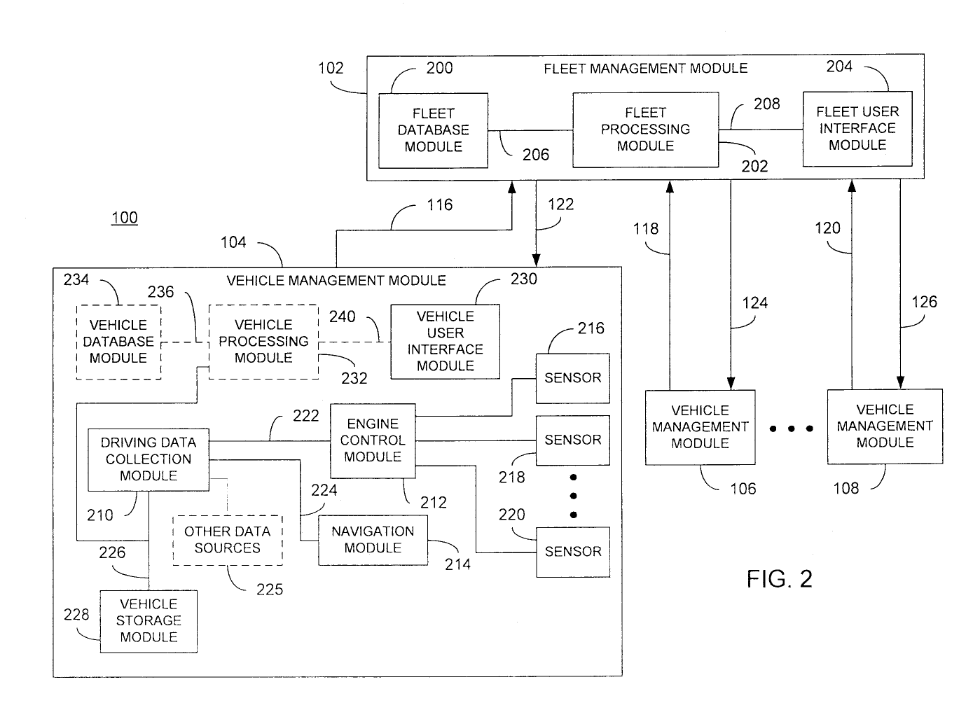

Referring now to FIG. 2, a more detailed block diagram of the driving management system 100 is depicted. As noted above, the driving management system 100 includes the fleet management module 102 and the vehicle management modules 104, 106, 108. In this embodiment, the fleet management module 102 includes a fleet database module 200, a fleet processing module 202, and a fleet user interface module 204. The fleet database module 200 may comprise any suitable database or other storage means capable of storing the collective empirical vehicle operation information 206. In one embodiment, database module 200 comprises an extensible markup language (XML) configuration file or an appropriately programmed Structured Query Language (SQL) server, as known in the art. The fleet user interface module 204 may comprise any suitable interface to provide information to a user. For example, the fleet user interface module 204 can be a stationary, portable or handheld device and can comprise a user selection device such as a mouse, touch screen, touch pad or similar such devices as known to those having ordinary skill in the art, a display such as a flat-panel display, cathode ray tube or suitable monitor, and/or other output mechanisms such as lights, enunciators, speakers, or other components known to provide information to users. Furthermore, the fleet user interface module 204 may support a web interface or other remote access interface, as known in the art, thereby allowing remote users to access the fleet management module 102 and the information maintained thereby. In an embodiment, the fleet management module 102 may be implemented using one or more computers as known in the art.

As noted above, the fleet processing module 202 may compare individual vehicle operation information 116, 118, 120 with collective empirical vehicle operation information 206, stored in the fleet database module 200, to provide the individual comparison results. Thereafter, the fleet processing module 202 uses the individual comparison results to provide vehicle operation feedback that may be presented to a user. For example, in one embodiment in which the user is a driver of a vehicle, the fleet processing module 202 provides the vehicle operation feedback information 122 to a first vehicle management module 104 via the wired and/or wireless connection noted above. Alternatively, where the user is a fleet manager, the fleet management module 202 provides the vehicle operation feedback information 208 to the fleet user interface module 204 for presentation to the fleet manager.

In the illustrated embodiment, the vehicle management module 104 (being representative of the other vehicle management modules 106, 108) includes a driving data collection module 210, an engine control module 212, a navigation module 214, and multiple sensors 216, 218, 220. The engine control module 212 comprises any suitable known engine control module (ECM), engine control unit (ECU), powertrain control module (PCM), and/or other suitable control module known in the art that is capable of providing vehicle performance information 222 such as, for example, on-board diagnostic information (e.g., OBD, OBD II, etc.) and/or fuel consumption information based readings from the sensors 216, 218, 220 and other suitable vehicle information. The sensors 216, 218, 220 can comprise various known sensors that provide information to the engine control module 212 from which the vehicle performance information 222 can be obtained. For example, and by way of non-limiting example, the sensors 216, 218, 220 can comprise sensors capable of detecting, among other things, acceleration, engine speed, manifold pressure, air flow, engine temperature, oxygen, fuel mixture, speed, camshaft position, sparkplug timing, crankshaft position, fuel injection, exhaust gas recirculation, barometric information, environmental conditions, driver operational controls, tire pressure, oil pressure, oil degradation, braking, and/or other suitable engine system parameters known in the art. The navigation module 214 can comprise any suitable navigation module known in the art such as a global positioning satellite (GPS) receiver that is capable of providing vehicle position information 224.

In addition to the vehicle performance information 222 and vehicle position information 224, other types of data concerning the environment in which a vehicle is operating (i.e., unrelated to performance or location of the vehicle, but otherwise affecting operation of the vehicle) may be obtained from various other data sources 225. For example, such vehicle environment information may be obtained where the other data sources 225 comprise one or more load sensors for detecting the presence of trailer or the like being transported by the vehicle. In another embodiment, the other data sources 225 may comprise sensors for ascertaining conditions external to a vehicle, e.g., outside air temperature, relative humidity, pressure, etc.; presence of moisture on the vehicle's exterior; levels of ambient light; etc. In another embodiment, data available to the driving data collection module 210, e.g., vehicle location and/or time/date data, may be used to infer or ascertain other vehicle environmental information. Any suitable source for obtaining time/date data may be employed for this purpose. For example, where the navigation module 214 comprises a GPS receiver, highly accurate time/date data may be obtained from the navigation module. In this embodiment, such vehicle location and time/date data can be used to index other databases containing relevant environmental condition data, either after the fact or in real-time. For example, assume it is known that Driver X operated Vehicle A from 8 AM to 5 PM on Jan. 4, 2010 entirely within the city limits of Chicago. Based on this information, a database of weather conditions may be crossed-referenced to determine that, on that day, road conditions in Chicago were slippery from 8 am to noon. Further still, another database could be may be accessed to determine that a given segment of Driver X's route was down to single lanes of traffic from 3 PM to 3 AM due to road construction. As an example of real-time data, the location data may be employed to cross-reference data concerning road construction and/or traffic along the vehicle's current route to inform the vehicle's driver of upcoming conditions that may affect travel performance. By storing such data obtained in real-time, the actual effect on travel performance may also be determined after the fact. Further examples of obtaining vehicle environmental information in this manner will be readily apparent to those having ordinary skill in the art.

The driving data collection module 210 collects the vehicle performance information 222 and the vehicle position information 224 (and any vehicle environmental information, if provided) and stores such information as individual vehicle operation information 226 in a vehicle storage module 228. In an embodiment, the driving data collection module 210 may derive additional information based on the vehicle performance information 222. For example, as known in the art, a vehicle's vehicle identification number (VIN) may be obtained from an OBD II interface and used to extract the make, model, year, etc. of the vehicle. The vehicle storage module 228 can be any suitable storage module known in the art such as a memory (volatile or non-volatile) and/or other suitable data storage device. Although not shown, a suitable communication interface may be provided in the vehicle management module 104 capable of supporting communication of data between the vehicle management module 104 and the fleet management module 102. For example, the communication interface may comprise a suitable wireless transceiver supporting any of the wireless protocols noted above, or may comprise a transceiver that supports a hardwired communication path, again as noted above. In this manner, the individual vehicle operation information 226 stored in the vehicle storage module 228 can be provided 116 as necessary to the fleet management module 102.

Additionally, the vehicle management module 104 may comprise a vehicle user interface module 230 that is capable of providing information to, or receiving information from, a user. For example, the vehicle user interface module 230 may comprise a suitable visual display and/or a user selection device such as a mouse, a touch screen, touch pad or similar such devices as known to those having ordinary skill in the art, and/or other output mechanisms such as lights, enunciators, speakers, or other components known to provide information to users. In an embodiment, the vehicle user interface module 230 is configured to display or otherwise provide the vehicle operation feedback information 122 (obtained via the communication interface noted above) to a driver of the vehicle. Alternatively, the vehicle user interface module 230 may be used to display or otherwise provide any of the individual vehicle operation information 226 to the driver. In other embodiments, the vehicle user interface module 230 operates to collect information, such as a user identification, from a user thereof, which information may be provided to the driving data collection module 210 as part of, or in addition to, the vehicle performance information 222. For example, the vehicle user interface module 230 may comprise a suitable input interface that allows the user to enter his/her unique identification code. Alternatively, the vehicle user interface module 230 may comprise a suitable biometric reader capable of receiving and verifying a user's biometric data including, but not limited to, the user's fingerprints, facial features, iris patters, voice patterns, etc. Further still, based on knowledge of authorized operators of a given vehicle, less complex metrics may be employed to infer the identity of the user, such as the weight of the user (as determined, for example, by a suitable weight sensor deployed in a seat of the vehicle as part of or input to the vehicle user interface module 230). Where the vehicle is operated by multiple users according to a predefined schedule, knowledge of a time of operation of a vehicle may be used to further infer the identity of the user. Configurations of a suitable vehicle user interface module 230 capable of operating in this manner will be readily apparent to those having ordinary skill in the art.

In some embodiments (e.g., the de-centralized embodiments noted above), the vehicle management module 104 can optionally include a vehicle processing module 232 and a vehicle database module 234. The vehicle database module 230, which is similar to the fleet database module 200, can comprise any suitable database or other suitable storage means capable of storing collective empirical vehicle operation information 236 as received, for example, via the communication interface (not shown) and the vehicle processing module 232. In one embodiment, the vehicle database module 234 comprises an extensible markup language (XML) configuration file or an appropriately programmed Structured Query Language (SQL) server.

Similar to the fleet processing module 202, the vehicle processing module 232 in this embodiment compares the individual vehicle operation information 226 with the collective empirical vehicle operation information 236 to provide individual comparison results. As before, the vehicle processing module 232 uses the individual comparison results to provide vehicle operation feedback 240, which is presented to a user, such as a driver for example, via the vehicle user interface module 230. It is noted that, in those embodiments in which the functionality of the vehicle processing module 232 is not included in the vehicle management module 104, the vehicle user interface module 230 may interact directly (not shown) with any of the sources from which it obtains data to be displayed (e.g., the driving data collection module 210, vehicle storage module 228) or to which it provides user input data.

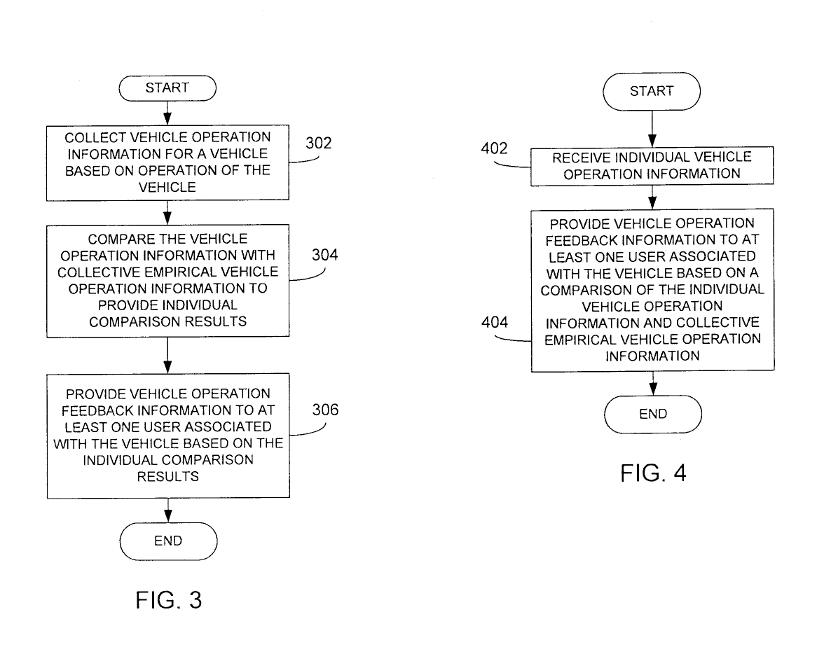

Referring now to FIG. 3, example operations that can be performed by the driving management system 100 are illustrated. At block 302, individual vehicle operation information is collected in response to operation of a vehicle. For example, and with reference to the embodiment illustrated in FIG. 2, the driving data collection module 210 collects the individual vehicle operation information 226 in response to operation of the respective vehicle 110. In the centralized embodiment noted above, the resulting individual vehicle operation information 116 is provided to the fleet processing module 202 or, in the de-centralized embodiment, the individual vehicle operation information 226 is provided to the vehicle processing module 232. Once again, it is noted that reference to a specific vehicle 110 and it corresponding vehicle management module 104 (or components thereof) is for illustrative purposes only as the operations described herein are equally applicable to the other vehicles 112, 114 and their corresponding vehicle management modules 106, 108.

Regardless of which processing module 202, 232 is employed, processing continues at block 304 where the processing module 202, 232 compares the individual vehicle operation information 116 with the collective empirical vehicle operation information 206, 236 to provide individual comparison results. In an embodiment, the comparison performed by the processing module 202, 232 is performed on a portion of the collective empirical vehicle operation information that is substantially similar in at least some respects to the individual vehicle operation information 116. That is, the differences between the individual vehicle operation information and a portion of the collective empirical vehicle operation information are most meaningful when the similarities between the two sets of vehicle operation information are first identified. In this embodiment, the process of first identifying similarities to define the information to be compared is performed on the basis of constraints (i.e., non-controllable factors) and variables (i.e., controllable factors) within the vehicle operation information. A constraint is any factor affecting vehicle operation/performance that is not controllable by a given user, whereas a variable is any factor affecting vehicle operation/performance that is controllable by the given user. Which factors within the vehicle operation information constitute constraints versus variables is necessarily context-dependent, specifically upon the role played by the particular user in question.

For example, where the user is a driver working for a delivery company, constraints may include requirements for completing a given delivery route in a certain amount of time, weather conditions, road conditions, time since most recent vehicle maintenance, a vehicle's type, make, model, year, etc., whereas variables may include vehicle speed, average rate of acceleration and/or deceleration (i.e., braking), gear selection, etc. Conversely, where the user is the fleet manager for the delivery company, constraints may again include weather conditions and road conditions, but may also include vehicle speed and/or average rate of acceleration. To the extent that the fleet manager can control assignment of specific drivers to specific vehicles, however, a vehicle's type, make, model, year, etc., and the identification of the driver are variables in the context of the fleet manager. Furthermore, where maintenance of the vehicle is performed only with the fleet manager's authorization, time since most recent vehicle maintenance becomes a variable in the context of the fleet manager. In yet another example of an individual car owner, constraints may typically include a vehicle's type, make, model, year, etc. (assuming the individual car owner does not operate his/her own fleet of vehicles), speed, acceleration/deceleration rate, driving route, transmission gear selection, tire pressure, oil degradation, time of day, etc. Although various examples of constraints and variables are identified above, those having ordinary skill in the art will appreciate that a variety of other factors may be considered as controllable or non-controllable information depending on a context of the user.

As noted above, in an embodiment, the comparison of individual vehicle operation information with the collective empirical vehicle operation information is based on constraints and variables. That is, a portion of the collective empirical vehicle operation information is identified based on constraints therein that are substantially similar to constraints in the individual vehicle operation information. First, one or more constraints within the individual vehicle operation information are identified. In one embodiment, this is done by determining what type of user is the intended recipient of the vehicle operation feedback information to be provided, i.e., by determining the context of the end user. In this embodiment, the available constraints and variables for each end user type or end user identification are pre-defined. For example, if end user can be characterized as either “delivery truck drivers” or “fleet managers”, then the various constraints and variables may be defined for each of these user types as noted in the previous examples. Alternatively, such predefined constraint/variable classification may be maintained on the basis of specific identifying information, such as identification of specific users or vehicles. For example, the combination of identifiers “user=John Doe” and the “vehicle=2008 Honda Civic” may correspond to a personal vehicle, and one set of constraints and variables may be identified for that context. In contrast, the combination of “user=John Doe” and “vehicle=2000 Mitsubishi Fuso FEHD” may instead correspond to a company-owned vehicle to which a second, different set of constraints and variables may apply. In this latter example, definition of such constraints and variables may be decided by an entity having authority over the company-owned vehicles and their use by employees, e.g., a fleet manager. Other embodiments for determining such constraints may also be used.

For example, rather than pre-defining context dependent constraints, a given user can be provided with a suitable interface permitting them to indicate such constraints, e.g., provide a graphical user interface via the vehicle user interface module 230 whereby a driver can indicate his/her constraints. Alternatively, machine learning techniques such as reinforcement learning may be employed. For example, assuming the identity of a driver is known (via simple user input, biometrics techniques, etc.), then depending on various other factors such as the time, the location of departure, etc., an underlying reinforcement learning model may be employed to guess the type of user and, consequently, the nature of his/her constraints. In this example, the driver can then confirm or deny the output of the model, thereby allowing the system to learn and improve over time with this feedback.

Regardless of the technique employed, having identified one or more constraints in the individual vehicle operation information, a portion of the collective empirical vehicle operation information may be identified based on one or more substantially similar constraints in the collective empirical vehicle operation information. As used herein, substantially similarity of constraints includes matching constraints, but may also include use of only a subset of the available constraints or the closest available constraints as well. For example, if the context indicates that “vehicle type” and “road condition” are constraints in the individual vehicle operation information, then the portion of the collective empirical vehicle operation information can be determined by identifying those instances in the collective empirical vehicle operation information in which “vehicle make”, “vehicle model” and “road condition” are also constraints having matching values (e.g. same vehicle make and model, and road with same topography and type). If constraints having matching values are not available (e.g., matching vehicle make and model, but no matching road topography/type), then the portion of the collective empirical vehicle operation information can be initialized based on attempts to maximize instances of matching constraints or at least identifying closest available constraints. For example, the portion of the collective empirical vehicle operation information may be identified as that portion for which matching constraints are available, i.e., by ignoring the non-matching constraints. Alternatively, where one or more constraints do not match, the closest available constraints (in addition to any matching constraints) could be used, e.g., where a constraint “vehicle make/model=Honda Accord” is not available within the collective empirical vehicle operation information, the constraint “vehicle make/model=Honda Civic” could be used instead.

Having identified a portion of the collective empirical vehicle operation information based on substantially similar constraints, the comparison between the individual vehicle operation information and the portion of the collective empirical vehicle operation information is performed on the basis of the available variables between the two sets of information. For example, for a given portion of the collective empirical vehicle operation information, the available variables may include “average vehicle speed” and “average rate of acceleration”. Presuming that data is also available in the individual vehicle operation information, then the comparison would be based on values for these variables from the individual vehicle operation information and the portion of the collective empirical vehicle operation information. Building on the previous example, it may be determined that the values of the “average vehicle speed” and “average rate of acceleration” in the individual vehicle operation information are 20 m/s and 3 m/s², whereas these values in the collective empirical vehicle operation information are 15 m/s and 2 m/s², then the comparison provides individual comparison results indicating that the driver is traveling 5 m/s faster and accelerating 1 m/s² faster relative to the collective empirical vehicle operation information.

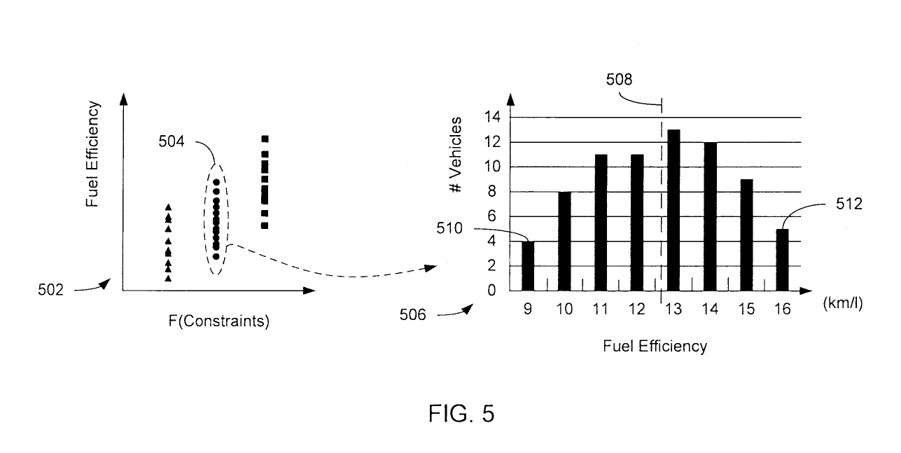

In an embodiment, the comparison thus performed may be on the basis of different values derived from the collective empirical vehicle operation information. For example, best, worst, average or median values derived from the collective empirical vehicle operation information may be employed for comparison with the values taken from the individual vehicle operation information. An example of this is illustrated in FIG. 5. In FIG. 5, collective empirical vehicle operation information 502 is shown as grouped according to various constraints, i.e., “F(Constraints)”. For example, each triangle data point may represent “fuel efficiency” for vehicles matching the constraints “vehicle make=Honda” and “year=2006”; each circle data point may represent “fuel efficiency” for vehicles matching the constraints “vehicle make=Ford” and “year=2008”; and each square data point may represent “fuel efficiency” for vehicles matching the constraints “vehicle make=Toyota” and “year=2009”. If the individual vehicle operation information to be compared includes constraints of “vehicle make=Ford” and “year=2008”, then the circle data points represent the portion of the collective empirical vehicle operation information 504 to be used in the comparison. Breaking down this portion of the collective empirical vehicle operation information 504, in histogram form 506, the number of vehicles for various values of fuel efficiency are shown. From this data, an average fuel efficiency value 508 may be computed and used for comparison purposes. Alternatively, a worst value 510 (i.e., 9 km/l) or a best value 512 (i.e., 16 km/l) may be employed for comparison purposes. Other value derivations based on the portion of the collective empirical vehicle operation information 504 may be equally employed as a matter of design choice. For example, more sophisticated statistical calculations may be employed in these comparisons, such as but not limited to, greater than a certain percentile, greater than a given number of standard deviations from the mean, etc.

Referring once again to FIG. 3, after determining the individual comparison results, processing continues at block 306 where the processing module 202, 232 provides the vehicle operation feedback information 208 to a user associated with the vehicle based on the individual comparison results. As noted above, the vehicle operation feedback information 122, 208, 240 provides information that suggests or instructs the user regarding ways to improve travel performance of one or more of the vehicles 110, 112, 114. As used herein, travel performance encompasses any one or more metrics that may be used to gauge optimal and/or beneficial use of a vehicle. For example, in an embodiment, travel performance is assessed solely on the basis of fuel efficiency. In this case, then, the vehicle operation feedback information provides suggested driving instructions that can be implemented by the user to improve fuel efficiency of the vehicle. Using the “average vehicle speed” and “average rate of acceleration” scenario and the individual comparison results noted above, the vehicle operation feedback information may include an indication that the driver's average vehicle speed is 33% higher and the driver's average acceleration rate is 50% higher, thereby suggesting that reducing average vehicle speed and average acceleration rate would result in improved travel performance.

Travel performance may also be gauged according to metrics such as usage efficiency of a vehicle or an external object relative to a vehicle. As used herein, usage efficiency of a vehicle is not directed to the actual performance of the vehicle itself, but its performance as part of a larger process. For example, in the case of a delivery vehicle, an important parameter to gauging performance is how quickly deliveries are made or, expressed alternatively, what percentage of deliveries are made on time. Further examples of usage efficiency metrics may include adjustment of the price/cost of operating the vehicle for a particular purpose, adjusting of time spent operating the vehicle, adjusting of distance traveled by the vehicle, etc. In a similar vein, external objectives relative to a vehicle comprise how well the vehicle is able to meet goals of entities having no direct relationship to the vehicle at all, e.g., entities other than the owner, driver or fleet manager. For example, in the case of a car rental company, certain customers (particularly environmentally aware customers) may pay a premium to use only vehicles that exhibit low pollution emissions. Those having ordinary skill in the art that still other metrics falling within these categories may be readily devised. Using metrics such as these permits for broader (and perhaps more relevant) assessment of travel performance than previous available.

In yet another embodiment, the various possible metrics available for assessing travel performance may be combined and adjusted in a joint fashion. For example, travel performance may be expressed as a function as shown in Equation 1:

$$Travel Performance = f ( fuel efficiency , on \text{-} time delivery , customer priority ) = A * fuel efficiency + B * on \text{-} time delivery + C * customer priority \qquad ( Eq . 1 )$$

where A, B and C are appropriately chosen weighting factors.

In this case, any of a number of well-known algorithms can be used to identify the adjusted vehicle operation information (i.e., variables) that increase (or in some cases maximize) travel performance metrics for the subset of data selected. Examples of such algorithms include swarm optimization; using multi-objective optimization evolutionary algorithms such as, for example, a non-dominated sorting genetic algorithm-II (NSGA-II) or strength pareto evolutionary approach 2; normal boundary intersection; using normal constraint; and using successive pareto optimization methods.

Referring now to FIG. 4, example operations that can be performed by the fleet processing module 202 and/or the vehicle processing module 232 are shown. That is, the processing illustrated in FIG. 4 presumes that the necessary vehicle operation information is available without specifying how such information is originally obtained. Thus, at block 402, the processing module 202, 232 receives the vehicle operation information 116, 118, 120, 226. Thereafter, at block 404, the processing module 202, 232 provides vehicle operation feedback information 208, 240, via the user interface module 204, 234, to a user associated with the vehicle (e.g., a driver and/or fleet manager) as described above. As previously noted, the vehicle operation feedback information 122, 124, 126, 208, 240 is based on a comparison of the vehicle operation information 116, 118, 120, 226 and the collective empirical vehicle operation information 206, 236, which is based on multiple vehicles 104, 106, 108. The vehicle operation feedback information 122, 124, 126, 208, 240 can then be used by the user to implement changes to improve travel performance, as further described above.

As noted above, among other features, the system and method uses collective empirical vehicle operation information, obtained from other vehicles, to provide vehicle operation feedback information, which can be implemented by a user to improve (or adjust) travel performance. Because the vehicle operation feedback information is based on empirically collected vehicle information, the system is continually adjusting itself to further improve travel performance. Improving travel performance, e.g., fuel efficiency, can substantially reduce costs associated with operating one or more vehicles in particular when used in conjunction with large fleets of vehicles. Furthermore, in the case of improved fuel efficiency, the air pollutants emitted by internal combustion engines associated with vehicles may be substantially reduced. Other features will be recognized by those of ordinary skill in the art.

While some embodiments of the present disclosure have been shown and described, it will be apparent to those skilled in the art that changes and modifications may be made without departing from the teachings of the disclosure. It is therefore contemplated that the present disclosure cover any and all modifications, variations or equivalents that fall within the scope of the basic underlying principles disclosed above and claimed herein.

What is claimed is:

1. A driving management system comprising:
a driving data collection module, deployed within a vehicle, that is operative to collect individual vehicle operation information for the vehicle based on operation of the vehicle; and
a processing module, operatively connected to the driving data collection module, that is operative to compare the individual vehicle operation information with collective empirical vehicle operation information to provide individual comparison results, and further operative to provide vehicle operation feedback information to at least one user associated with the vehicle based on the individual comparison results, wherein the collective empirical vehicle operation information is at least based on vehicle operation information for a plurality of other vehicles.

2. The driving management system of claim 1, wherein the processing module is deployed within the vehicle.

3. The driving management system of claim 1, wherein the processing module is deployed remotely relative to the vehicle.

4. The driving management system of claim 1, further comprising a database module operatively connected to the processing module, that is operative to store at least one of: the individual vehicle operation information and the collective empirical vehicle operation information.

5. The driving management system of claim 1, wherein the processing module, when providing the individual comparison results is further operative to:
identify at least one vehicle constraint in the individual vehicle operation information;
identify a portion of the collective empirical vehicle operation information having at least one constraint substantially similar to the at least one vehicle constraint;
identify at least one empirical variable in the portion of the collective empirical vehicle operation information; and
compare the at least one empirical variable with at least one vehicle variable of the individual vehicle operation information to provide the individual comparison results.

6. The driving management system of claim 5, wherein the at least one empirical variable comprises one of a best, worst, average and median value for the at least one empirical variable.

7. The driving management system of claim 1, wherein the processing module, when providing vehicle operation feedback information, is further operative to base the vehicle operation feedback information on adjustment of a travel performance metric.

8. The driving management system of claim 7, wherein the travel performance metric is based on at least one of: fuel efficiency of the vehicle, usage efficiency of the vehicle, and an external objective relative to the vehicle.

9. The driving management system of claim 1 wherein the vehicle operation feedback information includes information regarding at least one of: speed, acceleration, driving route, braking, transmission gear selection, or time of departure, or any combination thereof.

10. The driving management system of claim 1 further comprising a user interface, operatively connected to the processing module, that is operative to present the vehicle operation feedback information.

11. The driving management system of claim 10 wherein the user interface is deployed within the vehicle.

12. The driving management system of claim 10 wherein the user interface is deployed remotely relative to the vehicle.

13. The vehicle comprising the driving management system of claim 1.

14. A method of managing vehicle use comprising:
collecting individual vehicle operation information for a vehicle based on operation of the vehicle using a driving data collection module deployed within the vehicle;
comparing, using a processing module operatively connected to the driving data collection module, the individual vehicle operation information with collective empirical vehicle operation information to provide individual comparison results; and
providing, by the processing module, vehicle operation feedback information to at least one user associated with the vehicle based on the individual comparison results, wherein the collective empirical vehicle operation information is at least based on vehicle operation information for a plurality of other vehicles.

15. The method of claim 14 wherein the processing module is deployed within the vehicle.

16. The method of claim 14 wherein the processing module is deployed remotely relative to the vehicle.

17. The method of claim 14 further comprising storing at least one of: the individual vehicle operation information and the collective empirical vehicle operation information in a database module operatively connected to the processing module.

18. The method of claim 14 wherein comparing to provide the individual comparison results further comprises:
identifying at least one vehicle constraint in the individual vehicle operation information;
identifying a portion of the collective empirical vehicle operation information having at least one constraint substantially similar to the at least one vehicle constraint;
identifying at least one empirical variable in the portion of the collective empirical vehicle operation information; and
comparing the at least one empirical variable with at least one vehicle variable of the individual vehicle operation information to provide the individual comparison results.

19. The method of claim 18, wherein the at least one empirical variable comprises one of a best, worst, average and median value for the at least one empirical variable.

20. The method of claim 14 wherein providing the vehicle operation feedback information further comprises determining the vehicle operation feedback information based on adjustment of a travel performance metric.

21. The method of claim 20, wherein the travel performance metric is based on at least one of: fuel efficiency of the vehicle, usage efficiency of the vehicle, or an external objective relative to the vehicle, or any combination thereof.

22. The method of claim 14 wherein the vehicle operation feedback information includes information regarding at least one of either: speed, acceleration, driving route, braking, transmission gear selection, or time of departure, or any combination thereof.

23. A method of managing vehicle use comprising:
receiving individual vehicle operation information;
providing vehicle operation feedback information to at least one user associated with the vehicle based on a comparison of the individual vehicle operation information with collective empirical vehicle operation information, wherein the collective empirical vehicle operation information is at least based on vehicle operation information for a plurality of other vehicles.

24. The method of claim 23 wherein determining the comparison further comprises:
identifying at least one vehicle constraint in the individual vehicle operation information;
identifying a portion of the collective empirical vehicle operation information having at least one constraint substantially similar to the at least one vehicle constraint;
identifying at least one empirical variable in the portion of the collective empirical vehicle operation information; and
comparing the at least one empirical variable with at least one vehicle variable of the individual vehicle operation information,
wherein the vehicle operation feedback information is based on the comparison between the at least one empirical variable with the at least one vehicle variable.

25. The method of claim 24 wherein the at least one empirical variable comprises one of a best, worst, average and median value for the at least one empirical variable.

26. The method of claim 23 wherein providing the vehicle operation feedback information further comprises determining the vehicle operation feedback information based on adjustment of a travel performance metric.

27. The method of claim 26, wherein the travel performance metric is based on at least one of: fuel efficiency of the vehicle, usage efficiency of the vehicle, and an external objective relative to the vehicle.

28. The method of claim 23 wherein the vehicle operation feedback information includes information regarding at least one of: speed, acceleration, driving route, braking, transmission gear selection, or time of departure or any combination thereof.
